(19) United States
(12) Patent Application Publication
(10) Pub. No.: US 2006/0237875 A1
(43) Pub. Date: Oct. 26, 2006

(54) Releasable actuator rod assembly for a moving core element

(75) Inventor: Guido Drees, Lubbecke (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/112,284

(22) Filed: Apr. 21, 2005

(51) Int. Cl. B29C 45/00

(52) U.S. Cl. 264/328.1; 425/595

(57) ABSTRACT

A releasable actuator rod assembly for a moving core element in an injection mold tool in an injection molding machine has an axially elongated rod member of suitable length for extending into the injection mold tool in the injection molding machine. A T-shaped projection on one end of the rod member is received in a T-shaped slot on the moving core element. The rod member is rotatable between a locked position to engage the first end of the rod member with the moving core element and a second unlocked position to disengage the rod member from the moving core element. A pre-load detent housing retains the second end of the rod member to the actuating plate to restrain the rod member from rotating during operation to prevent disengagement between the rod member and the moving core element.

### TECHNICAL FIELD

The present invention relates generally to injection molding and deals more particularly with a releasable actuator rod assembly for a moving core element in an injection mold tool.

### BACKGROUND OF THE INVENTION

Various means are known for attaching moving core elements in mold tools in an injection molding machine. These attachment methods include long single piece core element components which extend back beyond the core element to locate on and attach to an anchor block on the actuating plate which is generally the ejector plate of the injection mold. Another known means for attaching moving core elements in mold tools is a two part solution in which an intermediate rod or bar is connected in a flexible manner to the back or rear face of the core element and its opposite end is located at and connected to an anchor block or other suitable feature on the actuating plate which is generally the ejector plate of the injection mold. These attachment methods are generally unsatisfactory and the attachments are difficult to assemble because the point of connection between the attachment and the moving core elements is within the mold tool and not easily accessible or visible to the assembler. Further, to change a moving core element in a mold tool while the mold tool is still in the injection molding machine requires that the core side of the mold tool be retained to the cavity side of the mold. Typically, a retaining strap is used to hold the mold tool. The core side of the mold tool is then unbolted or otherwise disassembled from the molding machine platen and the platens are then moved apart to expose the back of the core side of mold tool. If the mold tool is suitably designed, the parts of the tool can be disassembled to gain access to the actuation components and the core elements. The changing of a moving core element in typical mold tools is a difficult and time consuming process.

It would be desirable therefore to provide a means of attaching moving core elements in mold tools that facilitates and eases the assembly and disassembly of core elements in injection mold tools.

It is also desirable to provide a means of attaching moving core elements in mold tools such that the moving core elements can be changed without removing the mold tool from the injection molding machine.

### SUMMARY OF THE INVENTION

In accordance with a broad aspect of the invention, a releasable actuator rod assembly for a moving core element in an injection mold tool is presented. An axially elongated rod member has a suitable length for extending into an injection mold tool positioned in an injection molding machine and has a first end arranged for releasable engagement and disengagement with the moving core element in the injection mold tool, and a second end opposite the first end configured for retention by an actuating plate of the injection mold. The elongated rod is rotatable between a first locking position to engage the first end with the moving core element and a second unlocked position to disengage the first end from the moving core element. One of the first end of the rod member or the moving core element has a T-shaped projection and the other of the first end of the rod member or the moving core element has a T-shaped slot for receiving the T-shaped projection. The rod member is rotated one-quarter turn in a first direction to engage the rod member and the moving core element, and rotated a further one-quarter turn from the engaged position to disengage the rod member and the moving core element. A pre-load detent housing is provided for retaining the second end to the actuating plate to restrain the rod member from rotating during operation of the injection molding machine to prevent disengagement between the rod member and the moving core element. An axial keyway is provided in the second end of the rod member which is rotated by means of an elongated tool axially engaged with the axial keyway in the second end of the rod member.

In the second aspect of the invention, a releasable actuator rod assembly comprises an axially elongated rod member and a moving core element in an injection mold tool and a twist-lock arrangement for engaging and disengaging the rod member to and from respectively the moving core element. The twist-lock arrangement further comprises an axial T-shaped projection at one end of the axially elongated rod member and a T-shaped slot in the moving core element arranged to receive the rod member T-shaped projection. Twisting the rod member a predetermined degree of rotation with respect to the moving core element engagingly locks the rod member to the moving core element for movement with one another. Twisting the rod member a predetermined degree of rotation with respect to the moving core element from the locked position unlocks the rod member and the moving core element for disengagement and axial withdrawal of the rod member from the moving core element.

In a third aspect of the invention, a method for releasably engaging and disengaging an actuator rod assembly to and from a moving core element in an injection mold tool is presented and further comprises providing an axially elongated rod member having a suitable length for extending into the injection mold tool in an injection molding machine; arranging a first end of the rod member for releasable engagement and disengagement with the moving core element; configuring a second end of the rod member located opposite the first end for retention by an actuating plate of the injection mold, and rotating the rod between a first locking position to engage the first end of the rod member with the moving core element and a second unlocked position to disengage the first end of the rod member from the moving core element. The method further comprises arranging the first end of the rod member with a T-shaped projection and configuring the moving core element with a T-shaped slot for receiving the T-shaped projection. The method further comprises rotating the rod member one-quarter turn in a first direction to engage the rod member with the moving core element and rotating the rod member a further one-quarter turn from the engaged position to disengage the rod member from the moving core element. The method further comprises configuring the second end of the rod member with a pre-load detent housing to restrain the rod member from rotating during operation of the injection molding machine to prevent disengagement between the rod member and the moving core element. The method further comprises configuring the second end of the rod member with an axial keyway and rotating the rod member by means of an elongated tool axially engaged with the rod member axial keyway.

In a further aspect, the method comprises configuring the moving core element with a T-shaped projection and arranging the first end of the rod member with a T-shaped slot for receiving the T-shaped projection.

### BRIEF DESCRIPTION OF THE DRAWINGS

Other objects, features and advantages of the present invention will become readily apparent from the following written description taken with the figures wherein:

FIG. 1 is a schematic representation showing the actuator rod assembly in the unlocked position with a moving core element.

FIG. 2 is an enlarged schematic representation showing the engagement of the actuator rod assembly and moving core element in the unlocked position.

FIG. 3 is a schematic representation showing the actuator rod assembly in the locked position with a moving core element.

FIG. 4 is an enlarged schematic representation showing the engagement of the actuator rod assembly and moving core element in the locked position.

FIG. 5 is a schematic representation showing the T-slot in a moving core element.

FIG. 6 is a schematic representation showing the actuator rod held in the pre-load detent housing.

FIG. 7 is a schematic end plan view of the actuator rod held by a C-clip in the pre-load detent housing.

FIG. 8 is a schematic perspective view of the actuator rod showing the detent grooves and axial tool engagement slot in the end face of the actuator rod second end.

FIG. 9 is a schematic perspective view of the pre-load detent housing.

FIG. 10 is a schematic perspective view of the detent cam received in the pre-load detent housing.

FIG. 11 is a schematic perspective view of the pre-load spring used to bias the detent cam in the pre-load detent housing.

### WRITTEN DESCRIPTION OF PREFERRED EMBODIMENTS

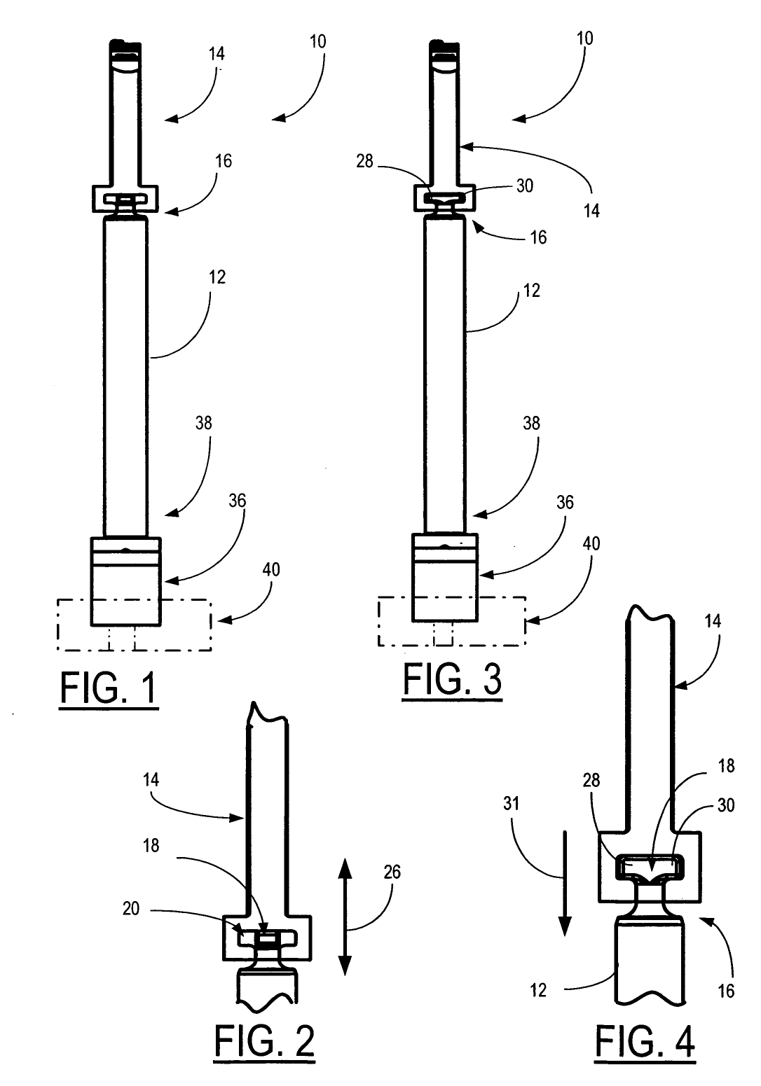

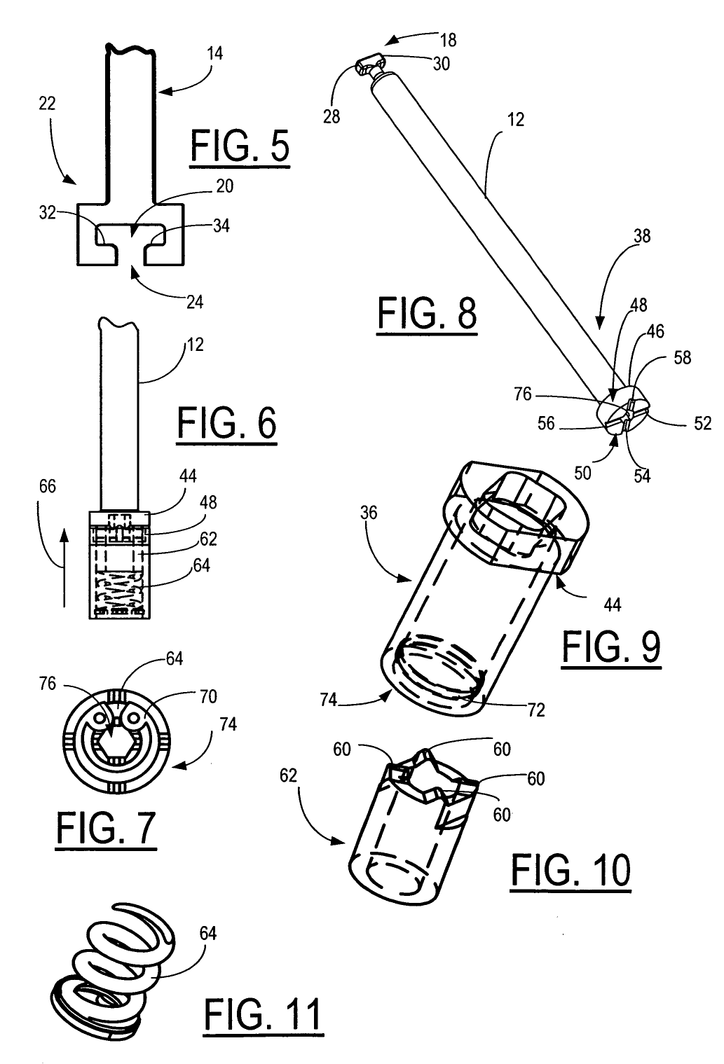

Turning now to the drawings and considering the invention in further detail, particularly with respect to FIGS. 1-5, a releasable actuator rod assembly generally designated 10 comprises an axially elongated rod member 12 having a suitable length for extending into an injection mold tool positioned in an injection molding machine is illustrated schematically therein. The rod member 12 is arranged for attachment to a moving core element generally designated 14 as best illustrated in FIG. 5. The elongated rod member 12 has a first end 16 arranged with a T-shaped projection generally designated 18 which is sized and configured for insertion into and removable from complementary T-shaped slot generally designated 20 formed in one end 22 of the moving core element 14. The rod member 12 is rotated such that the T-shaped projection is in alignment with the opening 24 to the T-shaped slot 20 in the end 22 of the moving core element 14. This is the unlocked operative position to allow engagement and disengagement of the actuator rod with the moving core element 14 as the rod 12 is moved into and out of the T-shaped slot 20 as illustrated by the direction arrow 26. When the rod member 12 is inserted into the T-shaped slot 20 in the unlocked operative position as illustrated in FIGS. 1 and 2, the rod 12 is rotated or twisted 90° or one quarter turn to its locked position as illustrated in FIGS. 3 and 4. The T-shaped projection 18 is now positioned, as best viewed in FIGS. 4 and 5, such that cheeks 28, 30 forming the T-shaped projection come into contact with the lower shelf surfaces 32, 34 defined in the T-shaped slot 20 to prevent the rod member 12 from disengagement with the moving core element 14 when a force is applied to the rod 12 in a direction corresponding to the direction arrow 31 with respect to the moving core element 14. Thus the rod member 12 remains engaged with the moving core element 14 during operation of the injection mold.

The rod member 12 is held at its second end 38 in a detent housing generally designated 36. The detent housing 36 is suitably configured and held and retained by an actuating plate shown in phantom in FIGS. 1 and 3 and generally designated 40 of the injection mold. In the locked operative position, the rod member 12 and the moving core element 14 move in a rectilinear motion in conjunction with movement of actuating plate 40 to position the moving core element 14 within the mold tool as is well known and understood by those skilled in the art. The housing 36 is configured and arranged as a pre-load detent housing to prevent the accidental rotation or twisting of the rod member 12 during operation of the injection molding machine to prevent inadvertent and unintended release and disengagement of the rod member 12 from the moving core element 14.

With reference FIGS. 6-11, it is seen that the detent housing 36 is slid axially over the rod member 12 and has a collar 44 at one end which engages with a peripheral flange 46 defined on one face of the cylindrical end portion 48 formed at the second end 38 of the rod member 12. The diameter of the peripheral end portion 48 is larger than the diameter of the rod member 12 and small than the inner diameter of the detent housing and collar 44. The outward facing face 50 of the peripheral end portion 48 includes grooves or slots 52, 54, 56, 58 in the face 50 defining indents which are spaced 90° relative to one another. The detents 52, 54, 56, 58 are sized and configured to receive the corresponding tips or projections 60 of the detent cam generally designated 62 when the rod member 12 is held in the pre-load detent housing as shown in FIG. 6. A pre-load spring 64 biases the detent cam 62 upward in the direction 66 to urge the tips 60, into the respective detents 52, 54, 56, 58 forcing the surface 46 of the peripheral section 48 into contact with the collar 44. The pre-load spring 64, detent cam 62, pre-load detent housing 36 and rod member 12 are retained when assembled by means of a C-clip 70 received in a groove 72 formed in the inner peripheral wall at the end 74 opposite the collar 44 as illustrated in FIG. 7.

As illustrated in FIGS. 7 and 8, the rod member 12 is configured with an axial keyway generally designated 76 having a suitable shape and size for complementary receiving and engagement with a tool such as a hexagonal wrench. The hexagonal wrench is passed through an aligned access hole in the actuating plate into the keyway 76 to rotate the rod member 12 into and out of its locked and unlocked operative positions.

A releasable actuator rod assembly for a moving core element in an injection mold tool has been described above in an exemplary embodiment. It will be recognized by those skilled in art that numerous changes and modifications may be made based on the above principles without departing from the spirit and scope of the invention. For example, the key shaped projection may be located on the rear face end of the moving core element and the complementary receiving T-slot may be located on the end of the rod member to accomplish the intended function and which configuration is particularly suitable for small core elements. Accordingly, the present invention is disclosed by way of illustration rather than limitation.

The invention claimed is:

1. A releasable actuator rod assembly for a moving core element in an injection mold tool, said actuator rod assembly comprising:
an axially elongated rod member having a suitable length for extending into an injection mold tool positioned in an injection molding machine;
said elongated rod having a first end arranged for releasable engagement and disengagement with the moving core element in the injection mold tool, and a second end opposite the first end configured for retention by an actuating plate of the injection mold;
said elongated rod being rotatable between a first locking position to engage said first end with said moving core element and a second unlocked position to disengage said first end from said moving core element.

2. The releasable actuator rod as defined in claim 1 wherein one of said first end and said moving core element has a T-shaped projection and the other of said first end and said moving core element has a T-shaped slot for receiving said T-shaped projection.

3. The releasable rod as defined in claim 2 wherein said rod member is rotated one-quarter turn in a first direction to engage said rod member and said moving core element, and rotated a further one-quarter turn from said engaged position to disengage said rod member and said moving core element.

4. The releasable actuator rod as defined in claim 3 further comprising a pre-load detent housing for retaining said second end to the actuating plate to restrain said rod member from rotating during operation of the injection molding machine to prevent disengagement between said rod member and said moving core element.

5. The releasable actuator rod as defined in claim 3 wherein said rod member second end further includes an axial keyway and is rotated by means of an elongated tool axially engaged with said axial keyway in said second end of said rod member.

6. A releasable actuator rod assembly, comprising:
an axially elongated rod member;
a moving core element in an injection mold tool; and
a twist-lock arrangement for engaging and disengaging said rod member to and from respectively said moving core element.

7. The releasable actuator rod assembly as defined in claim 6 wherein said twist-lock arrangement further comprises said axially elongated rod member having an axial T-shaped projection at one end, and said moving core element having a T-slot arranged to receive said rod member T-shaped projection wherein twisting said rod member a predetermined degree of rotation with respect to said moving core element engagingly locks said rod member to said moving core element for movement with one another and wherein twisting said rod member a predetermined degree of rotation with respect to said moving core element from the locked position unlocks said rod member and said moving core element for disengagement and axial withdrawal of said rod member from said moving core element.

8. Method comprising the steps of:
releasably engaging and disengaging an actuator rod assembly to and from a moving core element in an injection mold tool further comprising the steps of:
providing an axially elongated rod member having a suitable length for extending into the injection mold tool in an injection molding machine;
arranging a first end of the rod member for releasable engagement and disengagement with the moving core element,
configuring a second end of the rod member located opposite the first end for retention by an actuating plate of the injection mold;
rotating the rod between a first locking position to engage the first end of the rod member with the moving core element and a second unlocked position to disengage the first end of the rod member from the moving core element

9. The method defined in claim 8 further comprising the steps of:
arranging the first end of the rod member with a T-shaped projection, and
configuring the moving core element with a T-shaped slot for receiving the T-shaped projection.

10. The method defined in claim 9 further comprising the steps of:
rotating the rod member one-quarter turn in a first direction to engage the rod member with the moving core element, and
rotating the rod member a further one-quarter turn from the engaged position to disengage the rod member from the moving core element.

11. The method as defined in claim 10 further comprising the steps of:
configuring the second end of the rod member with a pre-load detent housing to restrain the rod member from rotating during operation of the injection molding machine to prevent disengagement between the rod member and the moving core element.

12. The method as defined in claim 11 further comprising the steps of:
further configuring the second end of the rod member with an axial keyway, and
rotating the rod member by means of an elongated tool axially engaged with the rod member axial keyway.

13. The method defined in claim 8 further comprising the steps of:
configuring the moving core element with a T-shaped projection, and
arranging the first end of the rod member with a T-shaped slot for receiving the T-shaped projection.
